(19) United States
(12) Patent Application Publication
(10) Pub. No.: US 2025/0368375 A1
(43) Pub. Date: Dec. 4, 2025

(54) DEVICE STABILIZER AND LABELING SYSTEM AND METHOD INCLUDING A DEVICE STABILIZER

(71) Applicant: Weiler Labeling Systems, LLC, Moorestown, NJ (US)

(72) Inventors: John Andrew SCOTT, Oreland, PA (US); Michael Andrew HYDE, Palmyra, NJ (US); Francis John HOLZER, Westampton, NJ (US); Edward S. YURGIN, Mullica Hill, NJ (US)

(21) Appl. No.: 19/206,679

(22) Filed: May 13, 2025

Related U.S. Application Data
(60) Provisional application No. 63/654,482, filed on May 31, 2024.

(51) Int. Cl. B65C 9/06

(52) U.S. Cl. CPC B65C 9/06

(57) ABSTRACT

A method is provided for stabilizing an elongated item during labeling of the elongated item, the elongated item including a housing sidewall extending axially along a length of the elongated item. The method involves: receiving the elongated item at an item holding station including a spring-loaded base and a gripper mechanism above the spring-loaded base, the gripper mechanism including opposed clamping arms; gripping the elongated item between the opposed clamping arms such that the opposed clamping arms engage the housing sidewall; and axially moving the elongated item downward relative to the opposed clamping arms such that the elongated item compresses the spring-loaded base. A labeling system for carrying out the method is also provided.

### TECHNICAL FIELD

The present application relates generally to label applying and, more particularly, to a device for holding an item while it is labeled.

### BACKGROUND

Labeling systems of various types are known, as are various devices for holding and stabilizing items to be labeled. Certain items require limited application of force when being held and/or labeled. For example, pharmaceutical autoinjector devices that are activated by axial force must be handled carefully during labeling.

Accordingly, it would be desirable to provide a device stabilizer capable of handling items that require special care, especially in terms of axial forces and torque.

### SUMMARY

In one aspect, a method is provided for stabilizing an elongated item during labeling of the elongated item, the elongated item including a housing sidewall extending axially along a length of the elongated item. The method involves: receiving the elongated item at an item holding station including a spring-loaded base and a gripper mechanism above the spring-loaded base, the gripper mechanism including opposed clamping arms; gripping the elongated item between the opposed clamping arms such that the opposed clamping arms engage the housing sidewall; and axially moving the elongated item downward relative to the opposed clamping arms such that the elongated item compresses the spring-loaded base.

In another aspect, a labeling system for labeling an elongated item includes an item holding station movable from an item loading location, past a labeling device for labeling and then to an item unloading location. The item holding station includes an upwardly biased base, a gripper mechanism above the upwardly biased base, the gripper mechanism including opposed gripping arms actuatable between an open condition and an item grip position for engaging the elongated item, and an item pusher located above the gripper mechanism, wherein the item pusher is actuatable, after the opposed gripping arms move to the item grip position and engage the elongated item, for moving the elongated item downward relative to the opposed gripping arms and against the upwardly biased base.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1 and 2 show perspective and top views of a labeling system;

FIGS. 3 and 4 show perspective views of portions of the labeling system;

FIGS. 5-13 show components of an item holding station;

FIG. 14 shows a top plan schematic of movement of a label holding station relative to a cam surface;

FIGS. 15 and 16 show top plan views of a gripper mechanism in an open condition and an item grip position, with no item shown;

FIGS. 17 and 18 show top plan views of a gripper mechanism in the open condition and the item grip position, with an item shown;

FIG. 19 shows a cross-section of portions of a pneumatic actuator of an item holding station; and

FIG. 20 shows a cross-section taken along a plane at a height that intersects with the stabilizer pads.

### DETAILED DESCRIPTION

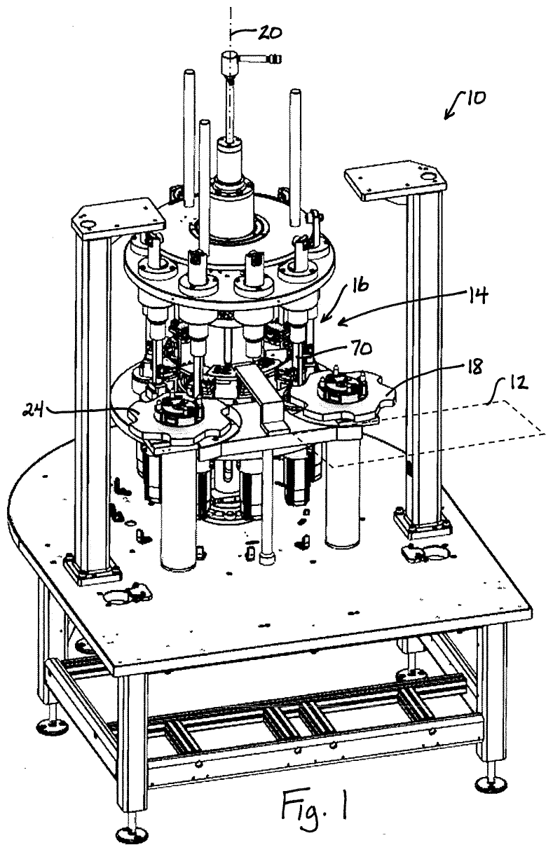

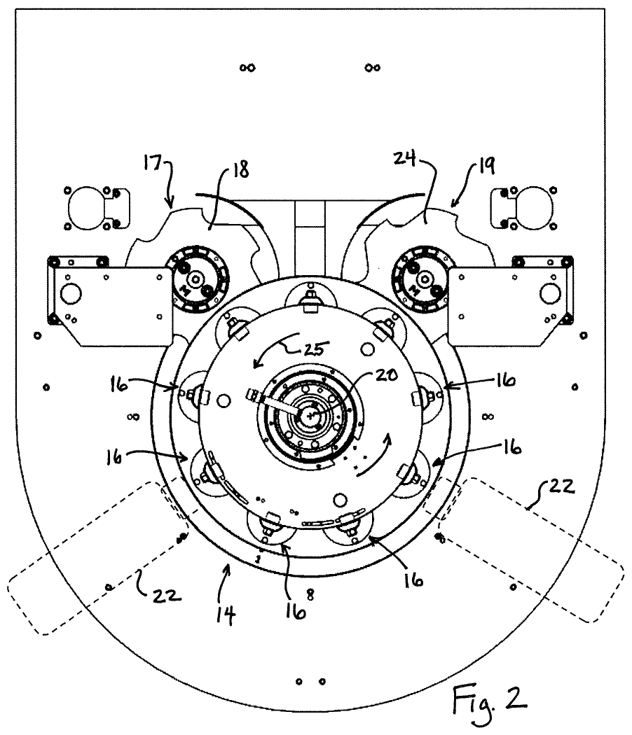

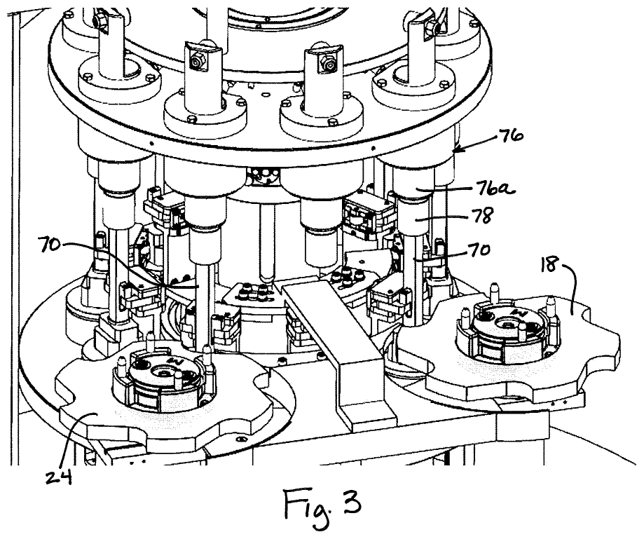

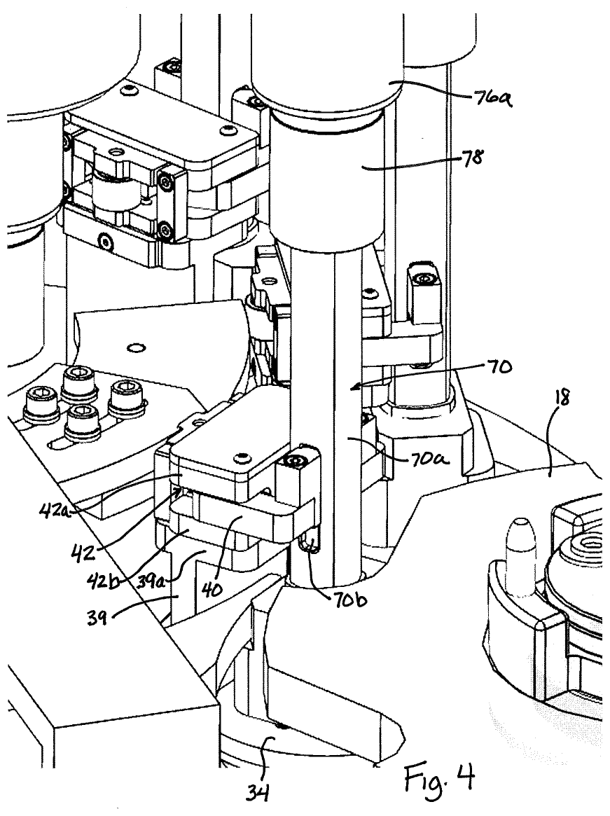

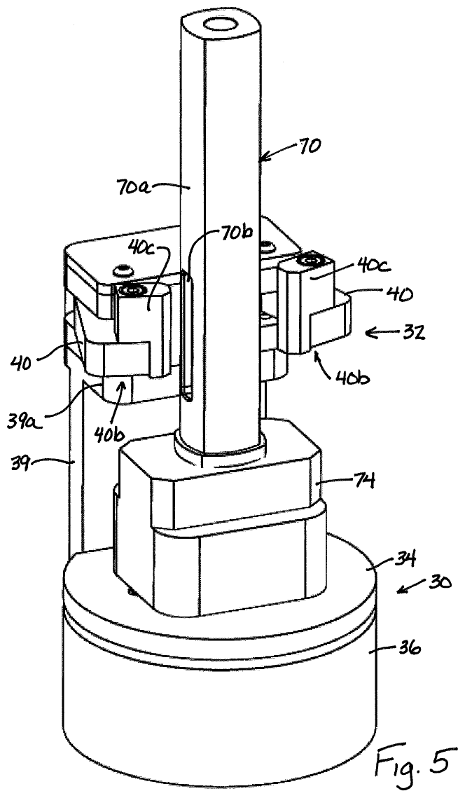

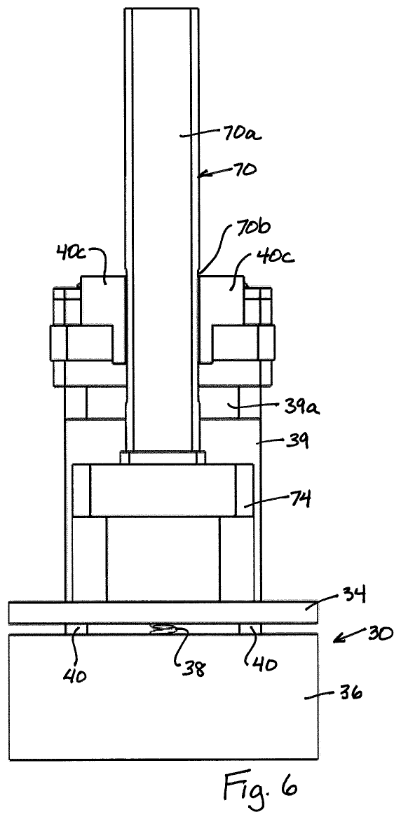

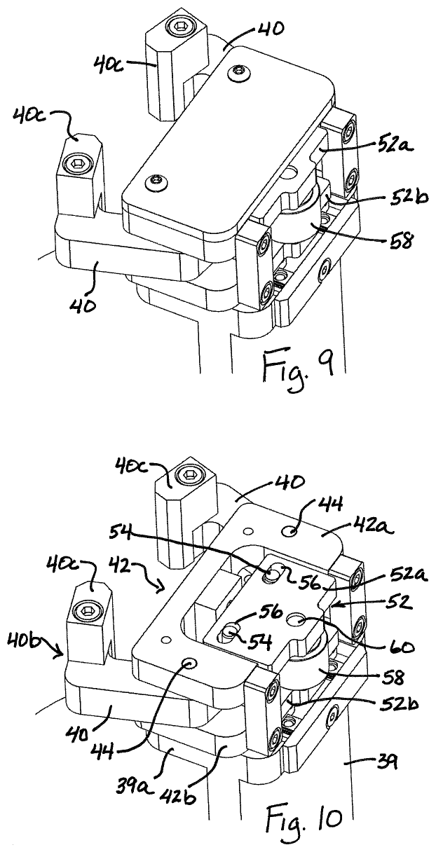

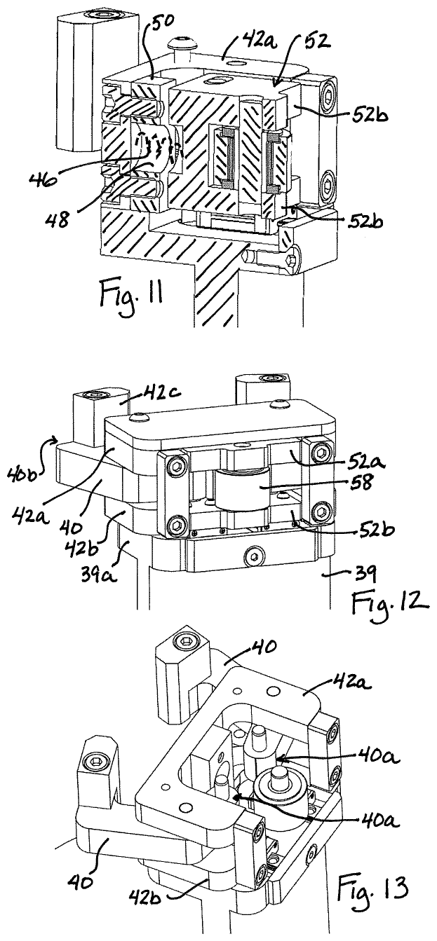

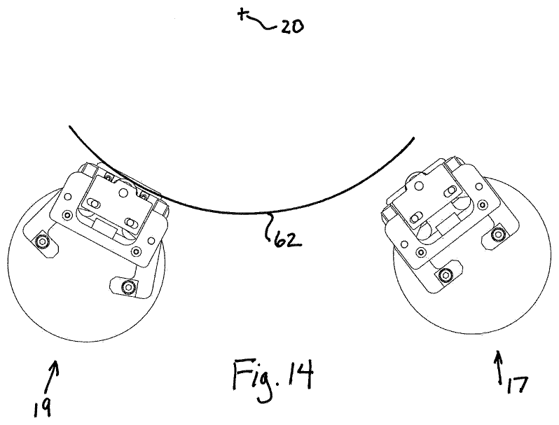

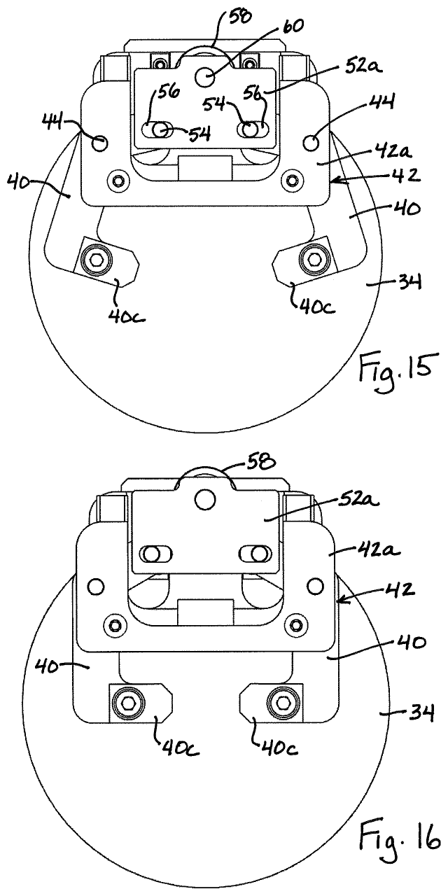

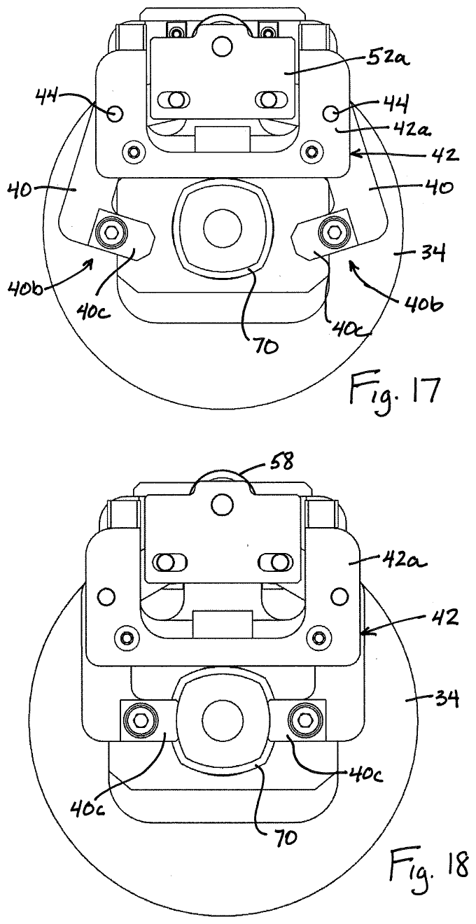

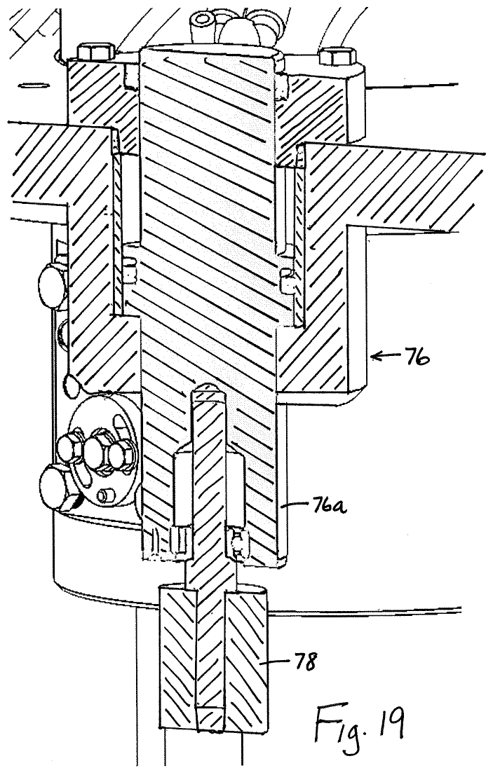

Referring to FIGS. 1-19, a label applying system 10 includes a schematically depicted linear conveyance path 12 (e.g., formed by any suitable conveyor technology, such as a roller conveyor or belt conveyor) for moving items 70 to a rotatable assembly 14 that includes multiple item holding stations 16 distributed therearound. As an alternative to the linear conveyance path 12, items could be fed by another rotating assembly. In either case, items are moved into the item holding stations 16 at an item loading location 17 a rotating pusher 18, then gripped and moved, per arrow 25, with the holding station about an axis 20 of the assembly 14 and past one or more labeling devices 22 that operate to apply one or more labels to each item as the item moves past. After labeling, the items exit the rotatable assembly 14, after being released, and are moved out at an item unloading location 19 by a rotating pusher 24 (which may move the items onto another conveyor or rotating assembly for subsequent handling).

Each holding station 16 includes an item support 30 and an item gripper mechanism 32. The item support 30 includes a base 34 that is biased upwardly. Here the base 34 is in the form of a base plate that is attached to a component, such as a block 36, and is axially movable up and down relative thereto by a small amount (e.g., between 3 mm and 6 mm). One or more springs 38 are disposed between the base plate 34 and the block 36 to bias the base plate 34 upwardly. In one example, the base plate is slidable along one or more mount posts 40 during axial movement relative to the block 36. A column 39 is fixed to the block 36 (e.g., via fasteners) and extends upwardly from a periphery of the block 36 and forms a mount platform 39a for the gripper mechanism 32.

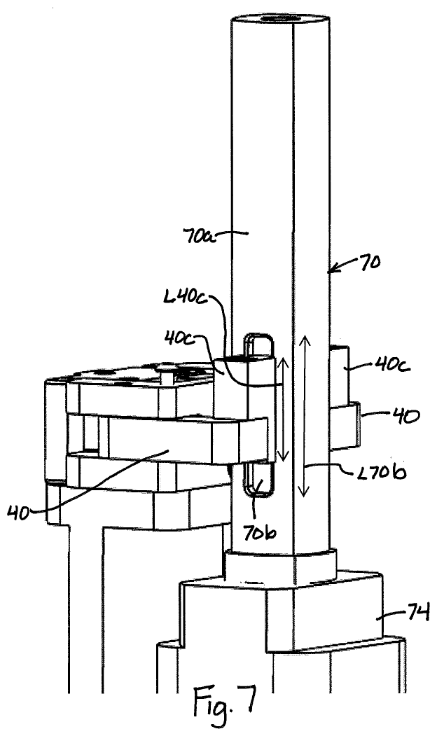

The gripper mechanism 32 includes at least one clamping or gripping arm, such as a pair of opposed clamping or gripping arms 40 that are pivotably movable between an open condition (FIG. 5) and an item grip position (FIG. 7). As an item is initially moved by the rotating pusher 18 into the holding station 16 at the item loading location 17, the clamping arms 40 are in the open condition and the clamping arms 40 move to the item grip position to engage the item 70 after or as the item is received at the item holding station. The opposite movement of the clamping arms 40 occurs at the unload location 19 defined by the rotating pusher 24.

In the illustrated embodiment, the clamping arms 40 are pivotably mounted to a mount frame 42 with upper and lower mount plates 42a, 42b (e.g., by dowel pins 44). The mount frame 42 is fixed atop the mount platform 39a (e.g., via fasteners). The clamping arms 42 are biased into the item grip position by a spring 46 located in a spring chamber 48 of a spring chamber block 50. The spring 46 pushes against an actuating bracket 52 with upper and lower plate portions 52a, 52b. The actuation ends 40a of the clamping arms 40 extend between and are pivotably mounted to the plate portions 52a, 52b (e.g., via dowel pins 54 that can slide within slots 56). The spring 46 therefore urges the actuating bracket 52 rearwardly or radially inward toward the rotation axis of rotating assembly 14. A roller 58 is rotatably mounted between the plate portions 52a, 52b (e.g., by a dowel pin 60). The roller 58 and actuating bracket 52 operate as a cam follower that interacts with a cam, such as cam surface 62, during at least part of the movement about the axis 20 of the assembly 14. More specifically, to place the clamping arms in the open condition, the roller 58 engages with and rolls along the cam surface 62 which forces the actuating bracket 42 radially outward from the axis 20 in order to open the clamping arms 40 at the item unload location 19, and the roller disengages from the cam surface 62 at the item load location 17 to close the clamping arms 40 onto the incoming item.

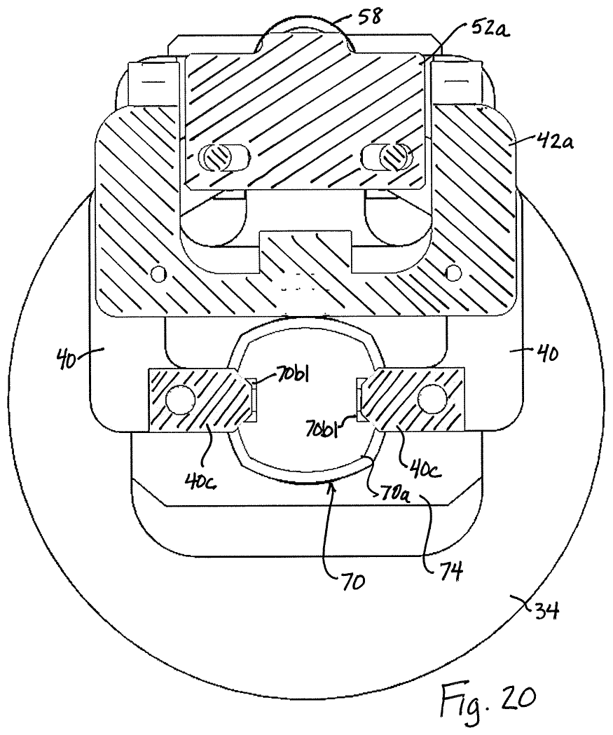

The grip ends 40b of the clamping arms 40 carry stabilizer pads 40c that engage with the items. In particular, here, each item 70 is an elongated item with a housing sidewall 70a extending axially along a length of the elongated item. The housing sidewall 70a includes opposite slots 70b into which the stabilizer pads 40c engage for gripping the item. An axial length or height dimension L40c of the stabilizer pads 40c is less than an axial length or height L70b of the slots 70b. This allows for some relative axial movement between the stabilizer pads 40c and the item 70 even after the clamping arms 40 engage with and grip the item 70. The stabilizer pads 40c may, for example, be made of an engineering thermoplastic, such as a thermoplastic with high stiffness, low friction, and excellent dimensional stability. The item contacting side of each of the stabilizer pads 40c is tapered, and, per FIG. 20, here takes the general shape of an isosceles trapezoid in a cross-section view taken into a plane perpendicular to the height of the pads. The stabilizer pads 40c clamp onto the outer surface of the item sidewall 70a as well as outer edge portions of the slots 70b. The depth of engagement into the slots is limited so the stabilizer pads 40c do not bottom out on the bottom wall 70b1 that defines the slot depth, which bottom wall in some cases may be defined by a clear plastic window allowing for viewing of internal portions of the item.

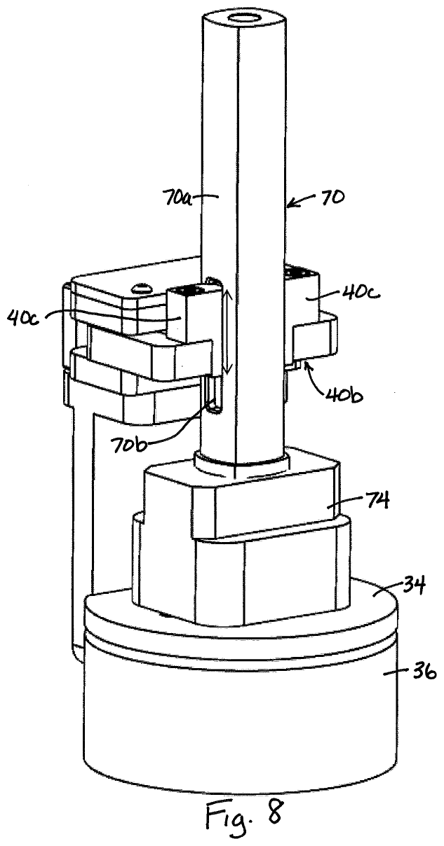

Here, the lower end of the item 70 is disposed within a carrying puck 74. Each item holding location includes a pneumatic actuator 76 with an associated piston rod 76a having a pusher pad or block 78 attached thereto for movement therewith. As the item holding location approaches the item load location, the rod 76a and block 78 are in an upwardly retracted position that provide clearance for entry of the item 70 into the item holding location. After the gripper mechanism engages with the item (e.g., per FIG. 7), the pneumatic actuator 76 is actuated to move the piston rod 76a downward such that the block 78 engages the top of the item 70 and moves the item axially downward against the base 34. The item 70 slides axially relative to the stabilizer pads 40c during such movement, and the length of the axial movement is restricted by the length of the slots 70b. That is, the downward axial movement of the item 70 stops when the upper edges of the slots 70b engage the stabilizer pads 40c of the clamping arms 42 (e.g., see FIG. 7 item position vs. FIG. 8 item position).

The relative sizing and positioning of the components of the system are set such that only a slight downward axial movement of the items 70 occurs, causing only a slight corresponding downward axial movement of the base 34, against the upward bias of the spring 38, such that the base does not bottom out on the block 36. The resulting axial upward force on the lower end of the item 70 caused by the base 34 is thereby assured to be less than a set threshold limit. Where the items 70 are pharmaceutical autoinjector devices, this set threshold force is set well below the amount of force that would cause actuation of the autoinjector.

It is to be clearly understood that the above description is intended by way of illustration and example only, is not intended to be taken by way of limitation, and that other changes and modifications are possible.

1. A method of stabilizing an elongated item during labeling of the elongated item, the elongated item including a housing sidewall extending axially along a length of the elongated item, the method comprising:
receiving the elongated item at an item holding station including a spring-loaded base and a gripper mechanism above the spring-loaded base, the gripper mechanism including opposed clamping arms;
gripping the elongated item with a gripper; and
axially moving the elongated item downward relative to the gripper such that the elongated item compresses the spring-loaded base.

2. The method of claim 1, wherein the gripper comprises opposed clamping arms.

3. The method of claim 2, wherein the opposed clamping arms engage into side slots of the housing sidewall, wherein the elongated item is moved axially downward until upper edge portions of the side slots engage the opposed clamping arms.

4. The method of claim 3, wherein a distance of axial movement of the elongated item downward is limited by the upper edge portions of the side slots such that an axial force applied by the spring-loaded base upward on the elongated item does not surpass a set threshold force.

5. The method of claim 3, wherein the opposed clamping arms are movable between an open condition and an item grip position, wherein the opposed clamping arms are biased into the item grip position.

6. The method of claim 5, wherein the item holding station is located on a rotating platform, and the rotating platform moves past a label device after the elongated item has been moved axially downward to compress the spring-loaded base.

7. The method of claim 6, wherein the item holding station includes a cam follower operatively connected to the opposed clamping arms, and a cam is provided such that the cam follower is moved by the cam to shift the opposed clamping arms to the open condition prior to receiving the elongated item at the item holding station, and the cam follower rides off of the cam after or as the elongated item is received at the item holding station such that the opposed clamping arms move, under the bias, to the item grip position to engage the into the side slots.

8. The method of claim 1, wherein the spring-loaded base is a base plate that is attached to a block and that is axially movable up and down relative to the block, with one or more springs disposed between the base plate and the block.

9. A labeling system for labeling an elongated item, the labeling system comprising:
an item holding station movable from an item loading location, past a labeling device for labeling and then to an item unloading location, wherein the item holding station includes:
an upwardly biased base;
a gripper mechanism above the upwardly biased base, the gripper mechanism including at least one gripping arm actuatable between an open condition and an item grip position for engaging the elongated item; and
an item pusher, above the gripper mechanism, wherein the item pusher is actuatable, after the at least one gripping arm moves to the item grip position and engages the elongated item, for moving the elongated item downward relative to the at least one gripping arm against the upwardly biased base.

10. The labeling system of claim 9, wherein a distance of axial movement of the elongated item downward is limited by a feature on the elongated item such that an axial force applied by the upwardly biased base upward on the elongated item does not surpass a set threshold force.

11. The labeling system of claim 9, wherein the at least one gripping arm is biased into the item grip position.

12. The labeling system of claim 11, wherein the item holding station is located on a rotatable platform, and the rotatable platform moves past the labeling device after the elongated item has been moved axially downward to compress the upwardly biased base.

13. The labeling system of claim 12, wherein the item holding station includes a cam follower operatively connected to the at least one gripping arm, and a cam is provided such that the cam follower is moved by the cam to shift the cat least one gripping arm to the open condition prior to receiving the elongated item at the item holding station, and the cam follower rides off of the cam after or as the elongated item is received at the item holding station such that the at least one gripping arm moves, under the bias, to the item grip position to engage the item.

14. The labeling system of claim 9, wherein the upwardly biased base is a base plate that is attached to a component and that is axially movable up and down relative to the component, with one or more springs disposed between the base plate and the component.

15. The labeling system of claim 9, wherein the at least one gripping arm comprised opposed gripping arms for engaging into respective side slots of the item.
